(19) United States
(12) Patent Application Publication
(10) Pub. No.: US 2026/0148162 A1
(43) Pub. Date: May 28, 2026

(54) EQUIPMENT MANAGEMENT SYSTEM, EQUIPMENT MANAGEMENT DEVICE, EQUIPMENT MANAGEMENT METHOD, AND RECORDING MEDIUM

(71) Applicant: Mitsubishi Electric Corporation, Tokyo (JP)

(72) Inventor: Noriyuki SHIMIZU, Tokyo (JP)

(21) Appl. No.: 19/122,134

(22) PCT Filed: Feb. 13, 2023
(86) PCT No.: PCT/JP2023/004679

§ 371 Date: Apr. 17, 2025

(51) Int. Cl. G06Q 10/0631; G06Q 30/0283

(52) U.S. Cl. CPC G06Q 10/06316; G06Q 30/0283

(57) ABSTRACT

An equipment management system acquires equipment information including a model name and operating data of each of a plurality of pieces of equipment installed in a facility, receives an input of a maintenance priority indicating a priority of performing maintenance on the equipment, calculates two or more maintenance timings including a first maintenance timing for performing replacement of a component used in the equipment earlier and a second maintenance timing which is later than the first maintenance timing, based on an operating time obtained from the acquired operating data, receives an input of work information regarding a work time and a cost required for the replacement of the component of each of the pieces of equipment, and creates and outputs a maintenance plan for the equipment based on the calculated maintenance timing, the input maintenance priority, and the input work time and cost.

### CROSS-REFERENCE TO RELATED APPLICATION

This application is a U.S. national stage application of International Application No. PCT/JP2023/004679 filed on Feb. 13, 2023, the contents of which are incorporated herein by reference.

### TECHNICAL FIELD

The present disclosure relates to an equipment management system, an equipment management device, an equipment management method, and a program.

### BACKGROUND

In a case where maintenance on a plurality of pieces of equipment is performed, it is preferable from a viewpoint of cost to simultaneously perform maintenance on the plurality of pieces of equipment during a single trip because expenses such as transportation costs can be reduced. For example, Patent Document 1 discloses a system that proposes a combination of a maintenance timing and equipment to be maintained, which minimizes a total cost that is a sum of running costs and maintenance costs.

### PATENT DOCUMENT

Patent Document 1: PCT International Publication No. WO 2021/205983

In a case of equipment failure, an opportunity loss may occur. Examples of the opportunity loss include a case where a restaurant cannot operate due to air conditioner failure during the summer. Among equipment installed in a facility, some equipment has a significant impact on the opportunity loss, such as the example of a restaurant mentioned above, while other equipment has a small impact on the opportunity loss. However, although the technology disclosed in Patent Document 1 could have proposed a maintenance plan based on the combination of the maintenance timing and the equipment to be maintained, which minimizes the total cost of running costs and maintenance costs, there is a problem that a cost of the opportunity loss due to equipment failure cannot be taken into account.

### SUMMARY

The present disclosure has been made in view of the above-described circumstances, and an object of the present disclosure is to provide an equipment management system, an equipment management device, an equipment management method, and a program that propose a maintenance plan for equipment that also takes into account a cost of an opportunity loss.

An equipment management system according to the present disclosure includes: an equipment information acquisition unit to acquire equipment information including a model name and operating data of each of a plurality of pieces of equipment installed in a facility; a maintenance information reception unit to receive an input of a maintenance priority indicating a priority of performing maintenance on the equipment; a maintenance timing calculation unit to calculate two or more maintenance timings including a first maintenance timing for performing replacement of a component used in the equipment earlier and a second maintenance timing which is later than the first maintenance timing, based on an operating time included in the operating data acquired by the equipment information acquisition unit; a work information reception unit to receive an input of work information regarding a work time and a cost required for the replacement of the component of each of the pieces of equipment; and a maintenance plan creation unit to create and output a maintenance plan for the equipment based on the maintenance timing calculated by the maintenance timing calculation unit, the maintenance priority input to the maintenance information reception unit, and the work time and the cost input to the work information reception unit.

In addition, an equipment management device according to the present disclosure includes: an equipment information acquisition unit to acquire equipment information including a model name and operating data of each of a plurality of pieces of equipment installed in a facility; a maintenance information reception unit to receive an input of a maintenance priority indicating a priority of performing maintenance on the equipment; a maintenance timing calculation unit to calculate two or more maintenance timings including a first maintenance timing for performing replacement of a component used in the equipment earlier and a second maintenance timing which is later than the first maintenance timing, based on an operating time included in the operating data acquired by the equipment information acquisition unit; a work information reception unit to receive an input of work information regarding a work time and a cost required for the replacement of the component of each of the pieces of equipment; and a maintenance plan creation unit to create and output a maintenance plan for the equipment based on the maintenance timing calculated by the maintenance timing calculation unit, the maintenance priority input to the maintenance information reception unit, and the work time and the cost input to the work information reception unit.

Further, an equipment management method in an equipment management system according to the present disclosure includes: a step of acquiring, via an equipment information acquisition unit, equipment information including a model name and operating data of each of a plurality of pieces of equipment installed in a facility; a step of receiving, via a maintenance information reception unit, an input of a maintenance priority indicating a priority of performing maintenance on the equipment; a step of calculating, via a maintenance timing calculation unit, two or more maintenance timings including a first maintenance timing for performing replacement of a component used in the equipment earlier and a second maintenance timing which is later than the first maintenance timing, based on an operating time included in the operating data acquired by the equipment information acquisition unit; a step of receiving, via a work information reception unit, an input of work information regarding a work time and a cost required for the replacement of the component of each of the pieces of equipment; and a step of creating and outputting, via a maintenance plan creation unit, a maintenance plan for the equipment based on the maintenance timing calculated by the maintenance timing calculation unit, the maintenance priority input to the maintenance information reception unit, and the work time and the cost input to the work information reception unit.

Furthermore, a program according to the present disclosure causes a computer to execute: a step of acquiring equipment information including a model name and operating data of each of a plurality of pieces of equipment installed in a facility; a step of receiving an input of a maintenance priority indicating a priority of performing maintenance on the equipment; a step of calculating two or more maintenance timings including a first maintenance timing for performing replacement of a component used in the equipment earlier and a second maintenance timing which is later than the first maintenance timing, based on an operating time included in the operating data; a step of receiving an input of work information regarding a work time and a cost required for the replacement of the component of each of the pieces of equipment; and a step of creating and outputting a maintenance plan for the equipment based on the calculated maintenance timing, the input maintenance priority, and the input work time and cost.

According to the present disclosure, it is possible to propose a maintenance plan for equipment that also takes into account a cost of an opportunity loss.

### BRIEF DESCRIPTION OF DRAWINGS

FIG. 1 A system diagram showing an example of the configuration of an equipment management system according to a first embodiment.

FIG. 2 A schematic block diagram showing an example of the configuration of an air conditioner according to the first embodiment.

FIG. 3 A schematic block diagram showing an example of the configuration of an equipment management device according to the first embodiment.

FIG. 4 A diagram showing an example of a calculation result of a maintenance timing according to the first embodiment.

FIG. 5 A diagram showing an example of a maintenance plan according to the first embodiment.

FIG. 6 A flowchart showing an example of a maintenance plan creation process according to the first embodiment.

FIG. 7 A schematic block diagram showing an example of the configuration of an equipment management device according to a second embodiment.

FIG. 8 A flowchart showing an example of a maintenance plan creation process according to the second embodiment.

FIG. 9 A diagram showing a setting example of a work condition according to the second embodiment.

FIG. 10 A schematic block diagram showing an example of the configuration of an equipment management device according to a fourth embodiment.

FIG. 11 A schematic block diagram showing an example of the configuration of an equipment management device according to a fifth embodiment.

### DETAILED DESCRIPTION

Hereinafter, embodiments will be described with reference to the drawings.

### First Embodiment

First, an example of the configuration of an equipment management system according to the present embodiment will be described.

### (Configuration of Equipment Management System)

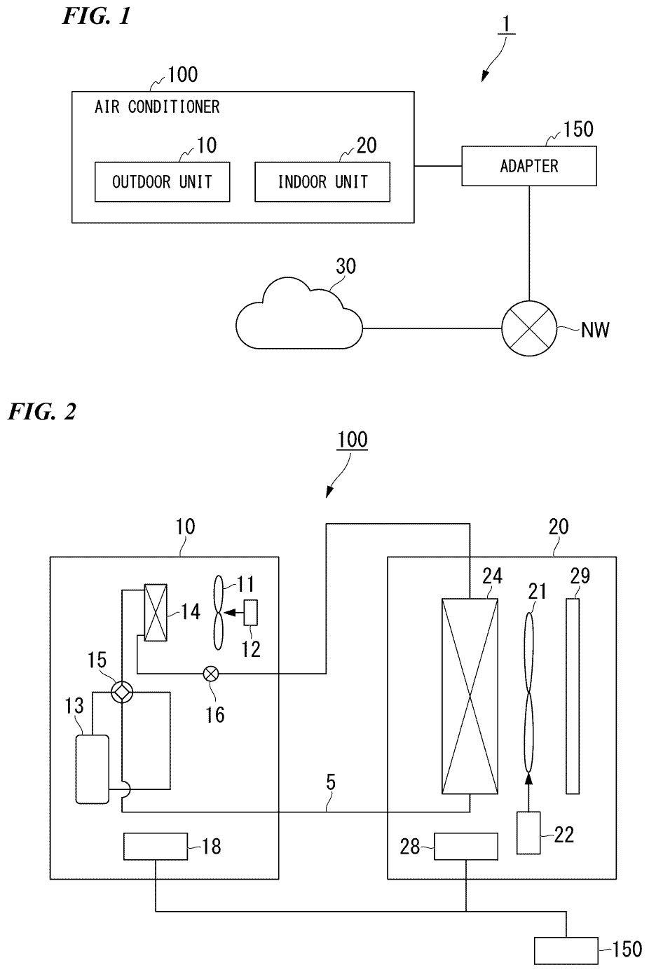

FIG. 1 is a system diagram showing an example of the configuration of an equipment management system according to the present embodiment.

An equipment management system 1 shown in the drawing is a system that manages equipment installed in a facility and that supports maintenance of the equipment. Here, an example is shown in which the equipment to be managed is an air conditioner. The equipment management system 1 includes an air conditioner 100 installed in the facility, an adapter 150, and an equipment management device 30.

The air conditioner 100 is connected to a communication network NW via the adapter 150. The adapter 150 is a device for connecting equipment, such as the air conditioner 100, to the communication network NW. The communication network NW includes the Internet, a mobile phone communication network, a local area network (LAN), and the like. For example, the air conditioner 100 includes an outdoor unit 10 and an indoor unit 20.

FIG. 2 is a schematic block diagram showing an example of the configuration of the air conditioner 100 according to the present embodiment. The outdoor unit 10 includes an outdoor unit fan 11, an outdoor unit fan motor 12 that drives rotation of the outdoor unit fan 11, an outdoor unit compressor 13, an outdoor unit heat exchanger 14, a four-way valve 15, an expansion valve 16, an outdoor unit control unit 18, and the like. The indoor unit 20 includes an indoor unit fan 21, an indoor unit fan motor 22 that drives rotation of the indoor unit fan 21, an indoor unit heat exchanger 24, an indoor unit control unit 28, a filter 29, and the like.

The outdoor unit 10 and the indoor unit 20 are connected to each other by a refrigerant pipe 5 through which a refrigerant flows. By switching the four-way valve 15 provided in the outdoor unit 10 to switch a circulation direction of the refrigerant, heating operation and cooling operation are switched.

In a case of the heating operation, the refrigerant in a gaseous state, which is compressed by the outdoor unit compressor 13, flows to the indoor unit heat exchanger 24 through the four-way valve 15. The refrigerant in the indoor unit heat exchanger 24 exchanges heat with surrounding air, thereby warming the surrounding air. The refrigerant that is brought into a liquid state by heat exchange flows into the outdoor unit heat exchanger 14 through the expansion valve 16. The refrigerant in the outdoor unit heat exchanger 14 exchanges heat with surrounding air. The refrigerant that is brought into a gaseous state by heat exchange returns to the outdoor unit compressor 13.

In a case of the cooling operation, the refrigerant in a gaseous state, which is compressed by the outdoor unit compressor 13, flows into the outdoor unit heat exchanger 14 through the four-way valve 15. The refrigerant in the outdoor unit heat exchanger 14 exchanges heat with surrounding air. The refrigerant that is brought into a liquid state by heat exchange flows into the indoor unit heat exchanger 24 through the expansion valve 16. The refrigerant in the indoor unit heat exchanger 24 exchanges heat with surrounding air, thereby cooling the surrounding air. The refrigerant that is brought into a gaseous state by heat exchange returns to the outdoor unit compressor 13.

The outdoor unit control unit 18 controls each unit provided in the outdoor unit 10. For example, the outdoor unit control unit 18 controls the outdoor unit fan motor 12 in accordance with an air volume setting or the like. The indoor unit control unit 28 controls each unit provided in the indoor unit 20. For example, the indoor unit control unit 28 controls the indoor unit fan motor 22 in accordance with the air volume setting or the like. Additionally, the indoor unit 20 is provided with the filter 29 for removing dust, dirt, gas, and the like in the air in a middle of an airflow generated by the rotation of the indoor unit fan 21 (for example, an airflow from the outside to the inside of the indoor unit 20).

In addition, the outdoor unit control unit 18 and the indoor unit control unit 28 have a communication function and are connected to each other by communication lines for communication between the outdoor unit control unit 18 and the indoor unit control unit 28 and for communication with the adapter 150.

Description returns to FIG. 1. The equipment management device 30 is configured with one or a plurality of server devices connected via the communication network NW and is configured as, for example, a cloud server. The equipment management device 30 and the air conditioner 100 can transmit and receive data via the communication network NW. In FIG. 1, although one air conditioner 100 is shown, a plurality of air conditioners 100 capable of communicating with the equipment management device 30 are present. For example, the equipment management device 30 communicates with the plurality of air conditioners 100 installed in the facility and managed as maintenance targets. Additionally, the equipment management device 30 communicates with a plurality of air conditioners 100 installed in each of a plurality of facilities and managed as maintenance targets.

For example, the equipment management device 30 acquires information on the air conditioners 100 by communicating with the plurality of air conditioners 100 installed in the facility and creates a maintenance plan.

### (Configuration of Equipment Management Device)

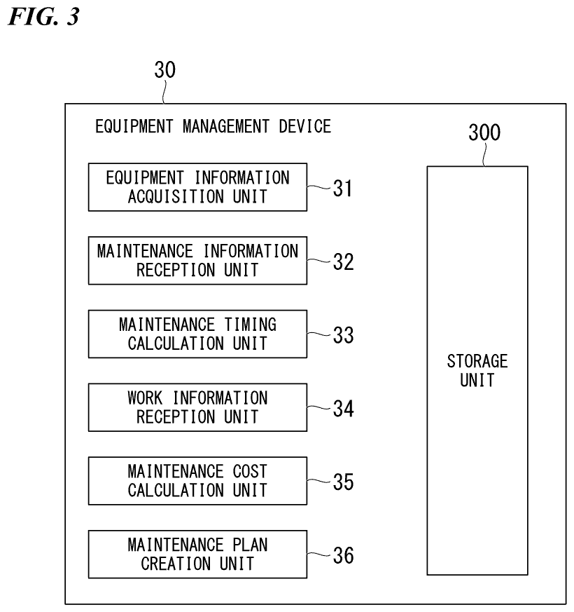

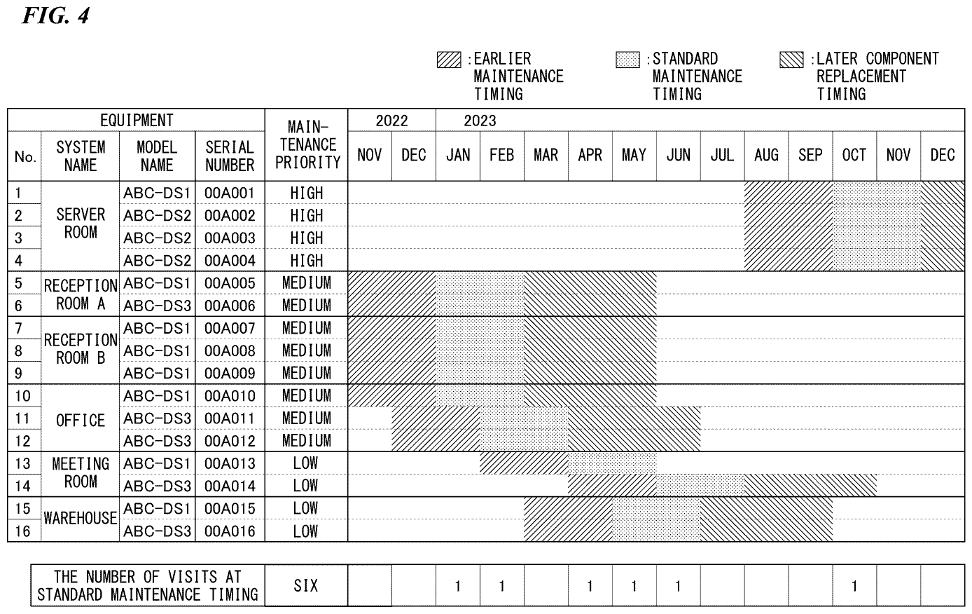

FIG. 3 is a schematic block diagram showing an example of the configuration of the equipment management device 30 according to the present embodiment. The equipment management device 30 is, for example, a server device equipped with a computer. For example, the equipment management device 30 includes an equipment information acquisition unit 31, a maintenance information reception unit 32, a maintenance timing calculation unit 33, a work information reception unit 34, a maintenance cost calculation unit 35, and a maintenance plan creation unit 36, as functional configurations implemented by a computer that executes a program. In addition, the equipment management device 30 includes a storage unit 300 that stores information acquired by each unit, information generated by each unit, and the like.

The equipment information acquisition unit 31 acquires equipment information including a model name and operating data of each of the plurality of air conditioners 100 installed in the facility. The operating data includes a start date of operation, an operating time (accumulated time the equipment has been in operation from the start of operation up to the present), and the like.

Additionally, the maintenance information reception unit 32 receives an input of a maintenance priority indicating a priority of performing maintenance on the air conditioner 100. The maintenance priority is determined by a user (for example, a facility manager) based on a degree of impact on an opportunity loss that occurs when the air conditioner 100 fails. For example, even in the same facility, the air conditioner 100 installed in a server room has a higher degree of impact on the opportunity loss occurring in a case of failure, and the air conditioner 100 installed in a warehouse has a lower degree of impact on the opportunity loss occurring in a case of failure. In that case, the maintenance priority of the air conditioner 100 installed in the server room is set higher, and the maintenance priority of the air conditioner 100 installed in the warehouse is set lower.

The input of the maintenance priority may be input from a controller (not shown) provided in the air conditioner 100 or may be input from a terminal device (for example, a personal computer, a smartphone, or the like) used by the user (for example, the facility manager).

The maintenance timing calculation unit 33 calculates two or more maintenance timings based on the operating time included in the operating data of the air conditioner 100 acquired by the equipment information acquisition unit 31. The maintenance timing refers to, for example, a component replacement timing for performing replacement of a component used in the air conditioner 100. The component to be replaced is, for example, a replaceable constituent component among constituent components of the air conditioner 100, such as the filter 29, the outdoor unit compressor 13, the outdoor unit fan motor 12, and the indoor unit fan motor 22.

For example, a standard operating time at which maintenance (for example, the replacement of the component) should be performed, an operating time for performing maintenance earlier with a priority on maintenance, and an operating time for performing maintenance later with a priority on cost are set in advance for each model name of the air conditioner 100. These can be set, for example, based on an analysis result of a correlation between the occurrence of component failure and a running time in the past for the same model or similar model of equipment. The maintenance timing calculation unit 33 checks the operating time up to the present of each air conditioner 100 based on the operating data acquired from the plurality of air conditioners 100 and calculates three maintenance timings for each air conditioner 100: a standard maintenance timing (for example, a component replacement timing), an earlier maintenance timing (for example, a component replacement timing) prioritized for the maintenance, and a later maintenance timing (for example, a component replacement timing) prioritized for the cost. Specifically, the standard maintenance timing refers to a timing at which the probability of a component failing in the next one year is estimated to be, for example, 50%, and the earlier maintenance timing prioritized for the maintenance refers to a timing at which the probability of a component failing in the next one year is estimated to be, for example, 20%. The later maintenance timing prioritized for the cost refers to a timing at which the probability of a component failing in the next one year is estimated to be, for example, 80%. The maintenance timing refers to, for example, a replacement timing of a component.

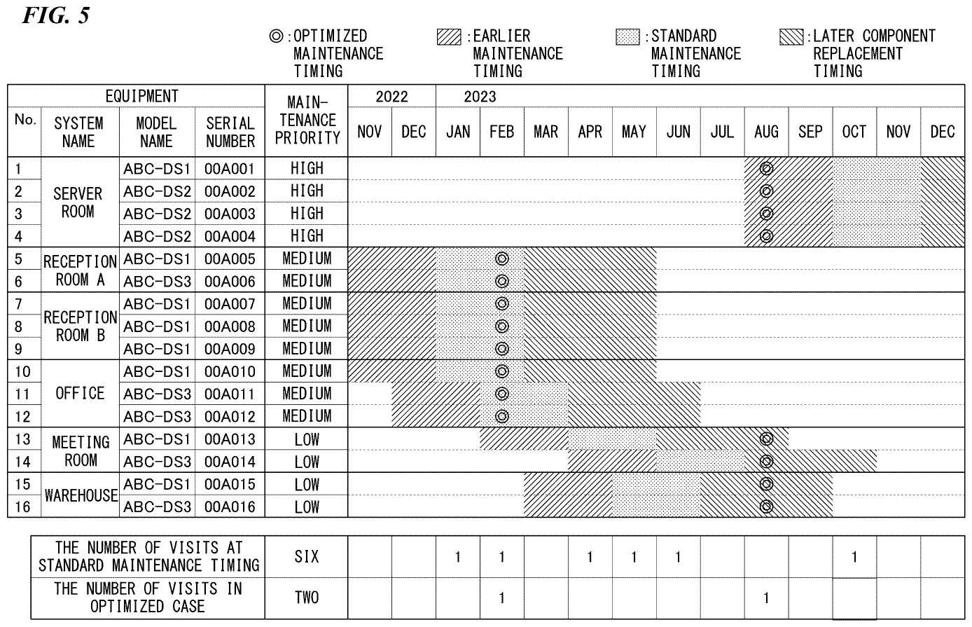

FIG. 4 is a diagram showing an example of a calculation result of the maintenance timing according to the present embodiment. This diagram shows calculation results of maintenance timings of 16 air conditioners 100 installed in the facility. In this facility, a total of 16 air conditioners 100 are installed: four in the server room, two in a reception room A, three in a reception room B, three in an office, two in a meeting room, and two in the warehouse. The air conditioners 100 include different models of equipment, and the operating times up to the present are also different. Therefore, the maintenance timing calculation unit 33 calculates the standard maintenance timing, the earlier maintenance timing, and the later maintenance timing of each of the air conditioners 100 based on each operating data. For example, in the shown example, the maintenance timings of the air conditioner 100 No. 5 installed in the reception room A are calculated as follows: the earlier maintenance timing is from November to December 2022, the standard maintenance timing is from January to February 2023, and the later maintenance timing is from March to May 2023.

In addition, the calculation results of the maintenance timings shown in the drawing also indicate the maintenance priority received by the maintenance information reception unit 32 as an input. In this example, the five air conditioners 100 installed in the server room are set with a high maintenance priority (“high”) because the impact on the opportunity loss occurring in a case of failure is significant. Further, the two air conditioners 100 installed in the meeting room and the two air conditioners 100 installed in the warehouse are set with a low maintenance priority (“low”) because the impact on the opportunity loss occurring in a case of failure is small. The other air conditioners 100 installed in the reception room A, the reception room B, and the office are set with a “medium” maintenance priority because, as compared to the meeting room and the warehouse, the areas have a higher frequency of human use, and the impact on the opportunity loss occurring in a case of failure is not as significant as in the server room, but there is still some impact.

For example, in a case where the maintenance on all the air conditioners 100 is performed in the first month of the standard maintenance timing, the total number of facility visits is six, with at least one visit each in January, February, April, May, June, and October of 2023. Since miscellaneous costs (miscellaneous expenses) such as transportation costs occur per visit, a higher number of visits leads to increased costs required for maintenance, which is not preferable.

In the present embodiment, in order to enable adjustment of the schedule for performing maintenance, the maintenance timing is given flexibility with three maintenance timings, that is, earlier, standard, and later maintenance timings. Therefore, it is possible to reduce the number of visits, thereby reducing the maintenance costs. For example, in a case where the maintenance on all the air conditioners 100 is consolidated on the same day, the number of visits is reduced to one, and the maintenance can be performed at the lowest cost. However, in a case where the number of visits is reduced to one, there is also an air conditioner 100 for which maintenance is performed later than the standard maintenance timing, thereby increasing the risk of failure. It may be acceptable if a failure occurs in an air conditioner 100 with a lower degree of impact on the opportunity loss, but in a case where an air conditioner 100 with a higher degree of impact on the opportunity loss fails, the cost of the opportunity loss may increase.

For example, in a case where the loss due to the failure of the air conditioner 100 is significant, such as in the server room where servers are installed or in a store that cannot operate without air conditioning, there may be a requirement to perform maintenance even at a higher cost to prevent failures. For such an air conditioner 100, by setting the maintenance priority higher and planning maintenance to be performed at the earlier maintenance timing or the earlier-to-standard maintenance timing, the risk of failure can be reduced. On the other hand, in a case where the loss due to the failure of the air conditioner 100 is small, by setting the maintenance priority lower and planning maintenance to be performed at the later maintenance timing or the standard-to-later maintenance timing, a reduction in the cost required for the maintenance can be expected.

In that regard, the equipment management device 30 according to the present embodiment creates a maintenance plan that reduces the cost required for maintenance and that also takes into account the cost of the opportunity loss, by consolidating maintenance timings of the air conditioners 100 such that the number of visits is reduced, in accordance with the maintenance priority set for each of the air conditioners 100.

FIG. 5 is a diagram showing an example of the maintenance plan according to the present embodiment. The maintenance plan shown in this diagram is a maintenance plan in which the maintenance timing for each of the air conditioners 100 is optimized and planned in accordance with the maintenance priority from among the standard maintenance timing, the earlier maintenance timing, and the later maintenance timing shown in FIG. 4. The optimized maintenance timing for each of the air conditioners 100 is indicated by the symbol “⊚”. By setting air conditioners 100 with a high maintenance priority to the earlier maintenance timing and air conditioners 100 with a low maintenance priority to the later maintenance timing, the maintenance timings are consolidated in August 2023. Additionally, by setting air conditioners 100 with a maintenance priority set to “medium” to the standard maintenance timing, the maintenance timings are consolidated in February 2023.

According to this maintenance plan, the number of facility visits is reduced to a total of two, that is, one in February 2023 and one in August 2023. Therefore, maintenance can be performed at a lower cost, as compared to a case where the number of visits required when all the air conditioners 100 are set to the standard maintenance timing is six. In addition, since the maintenance plan is created to perform maintenance on the air conditioner 100 with a high maintenance priority at the earlier maintenance timing, a maintenance plan that also takes into account the cost of the opportunity loss is obtained.

Description returns to FIG. 3. A functional configuration in which the equipment management device 30 creates a low-cost maintenance plan that also takes into account the cost of the opportunity loss from among the standard maintenance timing, the earlier maintenance timing, and the later maintenance timing will be described further.

The work information reception unit 34 receives an input of work information regarding a work time (for example, man-hours) required for maintenance (for example, the replacement of the component) of each of the air conditioners 100 and a cost (for example, component costs, miscellaneous expenses, and the like) required for maintenance. The miscellaneous expenses include expenses such as travel costs (such as transportation costs) for the worker to reach a location where maintenance is to be performed. Therefore, the component costs are not affected by the number of visits, but the miscellaneous expenses increase with a higher number of visits.

The maintenance cost calculation unit 35 selects a maintenance timing setting for each of the plurality of air conditioners 100 installed in the facility and calculates the maintenance cost required for the selected maintenance timing setting, based on the work time (for example, man-hours) and the cost (for example, component costs, miscellaneous expenses, and the like) required for maintenance, which are input to the work information reception unit 34.

For example, the maintenance cost calculation unit 35 selects a plurality of maintenance timing settings for each of the air conditioners 100 in accordance with the maintenance priority from among the standard maintenance timing, the earlier maintenance timing, and the later maintenance timing and calculates the maintenance cost required for each of the plurality of selected maintenance timing settings, based on the work time (for example, man-hours) and the cost (for example, component costs, miscellaneous expenses, and the like) required for maintenance, which are input to the work information reception unit 34.

The maintenance plan creation unit 36 creates and outputs the maintenance plan for the air conditioner 100 based on a maintenance timing setting with a lowest calculated maintenance cost among the plurality of maintenance timing settings selected by the maintenance cost calculation unit 35. That is, the maintenance plan creation unit 36 creates and outputs the maintenance plan for each air conditioner 100, which is the maintenance target in the facility, based on the maintenance timing calculated by the maintenance timing calculation unit 33, the maintenance priority input to the maintenance information reception unit 32, and the work time (for example, man-hours) and the cost (for example, component costs, miscellaneous expenses, and the like) required for maintenance input to the work information reception unit 34.

For example, the maintenance plan creation unit 36 outputs the maintenance plans for the air conditioners 100 No. 1 to No. 16 shown in FIG. 5. The maintenance plan shown in FIG. 5 is an example, and any aspect can be employed as long as the optimized maintenance timing for each air conditioner 100 is known. For example, in the maintenance plan shown in FIG. 5, the optimized maintenance timing is indicated by the symbol “⊚” but may be represented using text (for example, “February 2023”). Additionally, although the optimized maintenance timing for each air conditioner 100 is shown in a tabular form in the maintenance plan shown in FIG. 5, the optimized maintenance timing may be represented using text or the like at the installation location of the air conditioner 100 on the facility's layout (such as blueprints or floor plans).

The storage unit 300 stores the equipment information, the maintenance priority, the work information, and the like acquired by the equipment management device 30. In addition, the maintenance timing calculated by the equipment management device 30, the created maintenance plan, and the like are stored.

### (Operation of Maintenance Plan Creation Process)

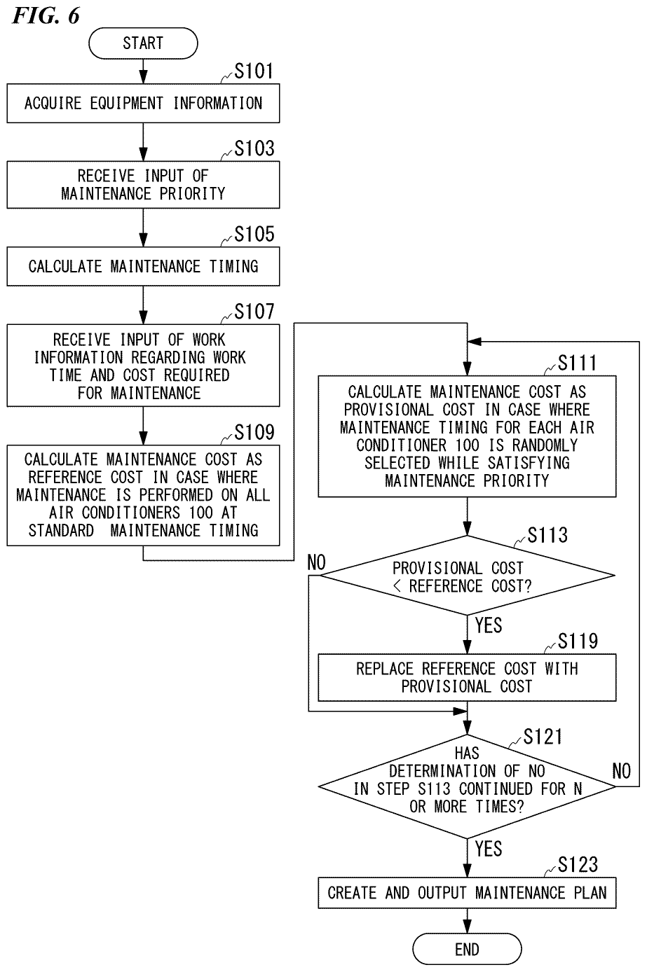

Next, an operation of a maintenance plan creation process of creating and outputting the maintenance plan via the equipment management device 30 will be described with reference to FIG. 6. FIG. 6 is a flowchart showing an example of the maintenance plan creation process according to the present embodiment.

(Step S101) The equipment management device 30 acquires the equipment information including the model name and the operating data (for example, the operating time) for each of the plurality of air conditioners 100 installed in the facility. Then, the process transitions to Step S103.

(Step S103) The equipment management device 30 receives an input of the maintenance priority indicating the priority of performing maintenance on each of the plurality of air conditioners 100 installed in the facility. Then, the process transitions to Step S105.

(Step S105) The equipment management device 30 calculates the maintenance timing (for example, the component replacement timing) based on the operating time included in the operating data of the air conditioner 100 acquired in Step S101. For example, the equipment management device 30 calculates the standard maintenance timing, the earlier maintenance timing prioritized for the maintenance, and the later maintenance timing prioritized for the cost, for each air conditioner 100 (refer to FIG. 4). Then, the process transitions to Step S107.

(Step S107) The equipment management device 30 receives an input of the work information regarding the work time (for example, man-hours) required for maintenance (for example, the replacement of the component) for each of the air conditioners 100 and the cost (for example, component costs, miscellaneous expenses, and the like) required for maintenance. Then, the process transitions to Step S109.

(Step S109) The equipment management device 30 calculates the maintenance cost in a case where maintenance is performed on all the air conditioners 100, which are the maintenance targets in the facility, at the standard maintenance timing, as a reference cost. Then, the process transitions to Step S111.

(Step S111) The equipment management device 30 calculates the maintenance cost in a case where the maintenance timing for each air conditioner 100, which is the maintenance target in the facility, is randomly selected while satisfying each maintenance priority, as a provisional cost. Then, the process transitions to Step S113.

(Step S113) The equipment management device 30 determines whether or not the provisional cost calculated in Step 111 is lower than the reference cost calculated in Step S109.

When the equipment management device 30 determines that the provisional cost is lower than the reference cost (YES), the process transitions to Step S119. On the other hand, when the equipment management device 30 determines that the provisional cost is not lower than the reference cost (NO), the processing of Step S119 is not performed, and the process transitions to Step S121.

(Step S119) The equipment management device 30 replaces the reference cost with the provisional cost. That is, the equipment management device 30 uses the provisional cost calculated in Step 111 as the reference cost to perform subsequent processing. Then, the process transitions to Step S121.

(Step S121) The equipment management device 30 determines whether or not the determination of NO (determination that the provisional cost is not lower than the reference cost) in Step S113 has continued for N or more times. Here, N is an integer of, for example, 1000 or greater and is set to a value such as 10000 as an example. In a case where the determination that the provisional cost is not lower than the reference cost (determination of NO) has continued for N or more times, it can be determined that the maintenance timing with a sufficiently low cost is selected. When the equipment management device 30 determines that the determination of NO in Step S113 has continued for N or more times (YES), the process transitions to Step S123. On the other hand, when the equipment management device 30 determines that the determination of NO in Step S113 has not continued for N or more times (NO), the process returns to Step 111 because there is a still possibility of selecting a maintenance timing with a lower cost.

(Step S123) The equipment management device 30 creates and outputs the maintenance plan for the air conditioner 100 based on the maintenance timing setting with the lowest calculated maintenance cost, among the maintenance timing settings for each air conditioner 100 selected in Step S111 (refer to FIG. 5). That is, the equipment management device 30 creates and outputs the maintenance plan for each air conditioner 100, which is the maintenance target in the facility, based on the maintenance timing calculated in Step S105, the maintenance priority input in Step S103, and the work time (for example, man-hours) and the cost (for example, component costs, miscellaneous expenses, and the like) required for maintenance input in Step S107.

As described above, in the equipment management system 1 according to the present embodiment, the equipment management device 30 includes the equipment information acquisition unit 31, the maintenance information reception unit 32, the maintenance timing calculation unit 33, the work information reception unit 34, and the maintenance plan creation unit 36. The equipment management device 30 acquires the equipment information including the model name and the operating data of each of the plurality of air conditioners 100 (an example of equipment) installed in the facility. The maintenance information reception unit 32 receives an input of the maintenance priority indicating the priority of performing maintenance on the air conditioner 100. The maintenance timing calculation unit 33 calculates two or more maintenance timings. For example, the maintenance timing calculation unit 33 calculates three maintenance timings (an example of two or more maintenance timings) including the earlier maintenance timing (an example of a first maintenance timing) for performing the replacement of the component used in the air conditioner 100 earlier, the standard maintenance timing (an example of a second maintenance timing) which is later than the earlier maintenance timing, and the later maintenance timing (an example of the second maintenance timing), based on the operating time included in the operating data acquired by the equipment information acquisition unit 31. The work information reception unit 34 receives an input of the work information regarding the work time (for example, man-hours) and the cost (for example, component costs, miscellaneous expenses, and the like) required for the replacement of the component of each of the air conditioners 100. The maintenance plan creation unit 36 creates and outputs the maintenance plan for the air conditioner 100 based on the maintenance timing calculated by the maintenance timing calculation unit 33, the maintenance priority input to the maintenance information reception unit 32, and the work time and the cost input to the work information reception unit 34.

As a result, since the equipment management system 1 creates the maintenance plan for the air conditioner 100 based on the plurality of maintenance timings (component replacement timings) obtained from the operating time of the air conditioner 100, the maintenance priority, and the work time and the cost required for maintenance (the replacement of the component), it is possible to propose the maintenance plan for the air conditioner 100 that reduces the cost required for maintenance and that also takes into account the cost of the opportunity loss.

The maintenance timing calculation unit 33 may calculate the earlier maintenance timing (an example of the first maintenance timing) for performing the replacement of the component used in the air conditioner 100 earlier and the standard maintenance timing (an example of the second maintenance timing) which is later than the earlier maintenance timing, based on the operating time included in the operating data acquired by the equipment information acquisition unit 31. Additionally, the maintenance timing calculation unit 33 may calculate the earlier maintenance timing (an example of the first maintenance timing) for performing the replacement of the component used in the air conditioner 100 earlier and the later maintenance timing (an example of the second maintenance timing) which is later than the earlier maintenance timing, based on the operating time included in the operating data acquired by the equipment information acquisition unit 31. Further, the maintenance timing calculation unit 33 may calculate the standard maintenance timing (an example of the first maintenance timing) for performing the replacement of the component used in the air conditioner 100 earlier and the later maintenance timing (an example of the second maintenance timing) which is later than the standard maintenance timing, based on the operating time included in the operating data acquired by the equipment information acquisition unit 31. Furthermore, the maintenance timing calculation unit 33 may calculate four or more maintenance timings.

In addition, the equipment management device 30 includes the maintenance cost calculation unit 35. The maintenance cost calculation unit 35 selects the plurality of maintenance timing settings for each of the air conditioners 100 in accordance with the maintenance priority input to the maintenance information reception unit 32, from among the two or more maintenance timings calculated by the maintenance timing calculation unit 33, and calculates the maintenance cost required for each of the plurality of selected maintenance timing settings based on the work time and the cost input to the work information reception unit 34. Then, the maintenance plan creation unit 36 creates the maintenance plan for the air conditioner 100 based on the maintenance timing setting with the lowest calculated maintenance cost among the plurality of maintenance timing settings selected by the maintenance cost calculation unit 35.

As a result, since the equipment management system 1 creates the maintenance plan for the air conditioner 100 based on the maintenance timing setting with the lowest maintenance cost among the maintenance timing settings selected in accordance with the maintenance priority from among the plurality of maintenance timings (component replacement timings) based on the operating time of the air conditioner 100, it is possible to propose the maintenance plan for the air conditioner 100 that reduces the cost required for maintenance and that also takes into account the cost of the opportunity loss.

The maintenance timing may be, for example, an inspection timing for performing inspection of the air conditioner 100, and the maintenance timing calculation unit 33 may calculate the inspection timing as the maintenance timing. Here, the inspection includes inspections mandated by law (such as simplified inspections performed at least once every three months, and regular inspections performed at least once a year or at least once every three years). As defined by “at least”, there is no issue with performing inspections earlier (that is, increasing the inspection frequency). However, since performing inspections later (that is, reducing the inspection frequency) is a violation of the law, the maintenance timing calculation unit 33 calculates the earlier maintenance timing and the standard maintenance timing for the inspection timing. That is, the maintenance plan creation unit 36 may create the maintenance plan for the component replacement timing from among the earlier, standard, and later maintenance timings, but may create the maintenance plan for the inspection timing from among the earlier and standard maintenance timings.

For example, the standard operating time at which the inspection should be performed and the operating time for performing the inspection earlier with a priority on maintenance are set in advance for each model name of the air conditioner 100. The maintenance timing calculation unit 33 may check the operating time up to the present of each air conditioner 100 based on the operating data acquired from the plurality of air conditioners 100 and may calculate the standard maintenance timing (inspection timing) and the earlier maintenance timing (inspection timing) prioritized for the maintenance, for each air conditioner 100. In a case of performing the inspection at the standard maintenance timing (inspection timing), the inspection can be performed at a lower cost than in a case of performing the inspection at the earlier maintenance timing (inspection timing).

Additionally, the maintenance information reception unit 32 may acquire inspection information regarding the inspection of the air conditioner 100. For example, the inspection information includes the standard operating time at which the inspection should be performed and the operating time for performing the inspection earlier with a priority on maintenance, for each model name of the air conditioner 100. The maintenance timing calculation unit 33 may calculate the maintenance timing (inspection timing) of the air conditioner 100 based on the equipment information acquired from the plurality of air conditioners 100 and the inspection information input to the maintenance information reception unit 32.

As a result, the equipment management system 1 can create the maintenance plan for the air conditioner 100 that reduces the cost required for maintenance and that also takes into account the cost of the opportunity loss, as the maintenance plan including the inspection of the air conditioner 100.

The maintenance plan creation unit 36 may create the maintenance plan from among earlier, standard, and later maintenance timings for inspections other than inspections mandated by law.

In addition, an equipment management method in the equipment management system 1 according to the present embodiment includes a step of acquiring, via the equipment information acquisition unit 31, the equipment information including the model name and the operating data of each of the plurality of air conditioners 100 (an example of the equipment) installed in the facility, a step of receiving, via the maintenance information reception unit 32, an input of the maintenance priority indicating the priority of performing maintenance on the air conditioner 100, a step of calculating, via the maintenance timing calculation unit 33, three maintenance timings (an example of two or more maintenance timings) including the earlier maintenance timing (an example of the first maintenance timing) for performing the replacement of the component used in the air conditioner 100 earlier, the standard maintenance timing (an example of the second maintenance timing) which is later than the earlier maintenance timing, and the later maintenance timing (an example of the second maintenance timing) based on the operating time included in the operating data acquired by the equipment information acquisition unit 31, a step of receiving, via the work information reception unit 34, an input of the work information regarding the work time (for example, man-hours) and the cost (for example, component costs, miscellaneous expenses, and the like) required for the replacement of the component of each of the air conditioners 100, and a step of creating and outputting, via the maintenance plan creation unit 36, the maintenance plan for the air conditioner 100 based on the maintenance timing calculated by the maintenance timing calculation unit 33, the maintenance priority input to the maintenance information reception unit 32, and the work time and the cost input to the work information reception unit 34.

As a result, through the equipment management method in the equipment management system 1, the maintenance plan for the air conditioner 100 is created based on the plurality of maintenance timings (component replacement timings) obtained from the operating time of the air conditioner 100, the maintenance priority, and the work time and the cost required for maintenance (the replacement of the component). Accordingly, it is possible to propose the maintenance plan for the air conditioner 100 that reduces the cost required for maintenance and that also takes into account the cost of the opportunity loss.

Further, a program according to the present embodiment causes the computer to execute a step of acquiring the equipment information including the model name and the operating data of each of the plurality of air conditioners 100 (an example of the equipment) installed in the facility, a step of receiving an input of the maintenance priority indicating the priority of performing maintenance on the air conditioner 100, a step of calculating three maintenance timings (an example of two or more maintenance timings) including the earlier maintenance timing (an example of the first maintenance timing) for performing the replacement of the component used in the air conditioner 100 earlier, the standard maintenance timing (an example of the second maintenance timing) which is later than the earlier maintenance timing, and the later maintenance timing (an example of the second maintenance timing), based on the operating time included in the acquired operating data, a step of receiving an input of the work information regarding the work time (for example, man-hours) and the cost (for example, component costs, miscellaneous expenses, and the like) required for the replacement of the component of each of the air conditioners 100, and a step of creating and outputting the maintenance plan for the air conditioner 100 based on the calculated maintenance timing, the input maintenance priority, and the input work time and cost.

As a result, the computer serving as the equipment management device 30 in the equipment management system 1 executes the above-described program, thereby creating the maintenance plan for the air conditioner 100 based on the plurality of maintenance timings (component replacement timings) obtained from the operating time of the air conditioner 100, the maintenance priority, and the work time and the cost required for maintenance (the replacement of the component). Accordingly, it is possible to propose the maintenance plan for the air conditioner 100 that reduces the cost required for maintenance and that also takes into account the cost of the opportunity loss.

### Second Embodiment

Next, a Second Embodiment Will Be Described.

In the first embodiment, in order to create the maintenance plan at the lowest-cost maintenance timing, a process of calculating the maintenance cost (provisional cost) by randomly selecting the maintenance timing of each air conditioner 100 (Step S111 in FIG. 6) has been described. In the present embodiment, the equipment management device 30 calculates the work time in a case where the maintenance on each air conditioner 100 is performed at the selected maintenance timing setting, and checks whether the maintenance timing setting satisfies predesignated work constraints (the number of workers, the number of workdays, and the like).

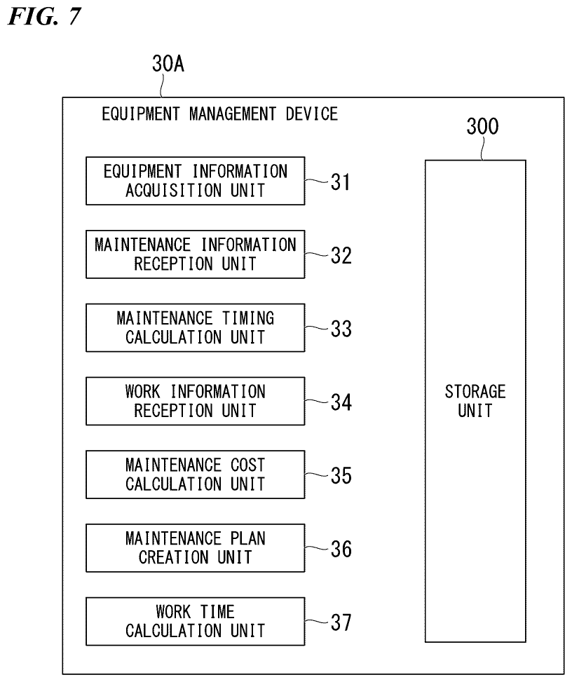

FIG. 7 is a schematic block diagram showing an example of the configuration of an equipment management device 30A according to the present embodiment. In this diagram, the same reference numeral is assigned to the configuration corresponding to each unit of the equipment management device 30 shown in FIG. 3. The equipment management device 30A is different from the equipment management device 30 shown in FIG. 3 in that a work time calculation unit 37 is further provided.

The work time calculation unit 37 calculates the work time in a case where maintenance is performed at each of the plurality of maintenance timing settings selected by the maintenance cost calculation unit 35. Then, the maintenance plan creation unit 36 determines whether or not the plurality of selected maintenance timing settings satisfy the predesignated work constraints (the number of workers, the number of workdays, and the like), and creates the maintenance plan based on the maintenance timing setting with the lowest calculated maintenance cost among the maintenance timing settings satisfying the predesignated work constraints (the number of workers, the number of workdays, and the like).

That is, in the present embodiment, the maintenance plan creation unit 36 creates the maintenance plan for the air conditioner 100 based on the maintenance timing setting that satisfies the predesignated work constraints (the number of people, the number of days, and the like) and that has the lowest calculated maintenance cost among the plurality of selected maintenance timing settings.

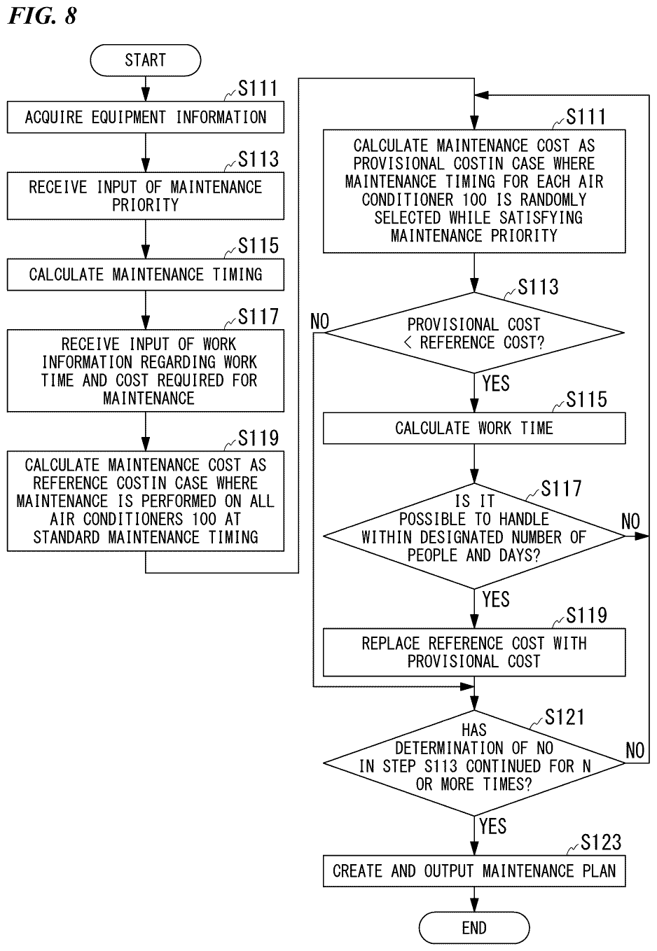

FIG. 8 is a flowchart showing an example of the maintenance plan creation process according to the present embodiment. In this diagram, the same reference numeral is assigned to processing corresponding to each processing shown in FIG. 6. The maintenance plan creation process shown in this diagram is different from the maintenance plan creation process shown in FIG. 6 in that processing of steps S115 and S117 is further performed. Here, differences from the maintenance plan creation process shown in FIG. 6 will be described.

In Step S113, when it is determined that the provisional cost is lower than the reference cost (YES), the equipment management device 30A transitions to Step S115.

(Step S115) The equipment management device 30A calculates the work time in a case where maintenance is performed at the maintenance timing setting selected when the provisional cost is calculated in Step 111. For example, the equipment management device 30A calculates the work time in a case where maintenance is performed at the maintenance timing setting selected when the provisional cost is calculated, based on the maintenance timing setting selected when the provisional cost is calculated and the work time input to the work information reception unit 34. Then, the process transitions to Step S117.

(Step S117) The equipment management device 30A determines whether or not the maintenance timing setting selected when the provisional cost is calculated can be handled within the designated number of people and days. For example, the equipment management device 30A determines whether or not the work time calculated in Step S115 satisfies the predesignated work constraints (the number of people, the number of days, and the like). When the equipment management device 30A determines that the predesignated work constraints (the number of people, the number of days, and the like) are satisfied (YES), the equipment management device 30A determines that the maintenance timing setting can be handled within the designated number of people and days, and the process transitions to Step S121. On the other hand, when the equipment management device 30A determines that the predesignated work constraints (the number of people, the number of days, and the like) are not satisfied (NO), the equipment management device 30A determines that the maintenance timing setting cannot be handled within the designated number of people and days, and the process returns to Step S111.

In this manner, the equipment management device 30A according to the present embodiment includes the work time calculation unit 37 that calculates the work time in a case where maintenance is performed at each of the plurality of maintenance timing settings selected by the maintenance cost calculation unit 35. Then, the maintenance plan creation unit 36 creates the maintenance plan for the air conditioner 100 based on the maintenance timing setting that satisfies the predesignated work conditions (the number of people and the number of days) and that has the lowest calculated maintenance cost among the plurality of selected maintenance timing settings.

As a result, in a case where there are constraints such as the predesignated number of workers and workdays, the equipment management system 1 can ensure that a maintenance plan that cannot be performed due to the constraints is not created.

The work time in a case where maintenance (for example, component replacement) is performed varies depending on the work content and the capabilities (for example, proficiency) of the worker. Additionally, the maintenance work also includes a standby time such as vacuum pumping or waiting for stable operation during trial runs. In order to be able to create a maintenance plan that takes into account such factors, it is also possible to set work conditions such as a standard work time, a standard standby time, and the capabilities (for example, proficiency) of the worker.

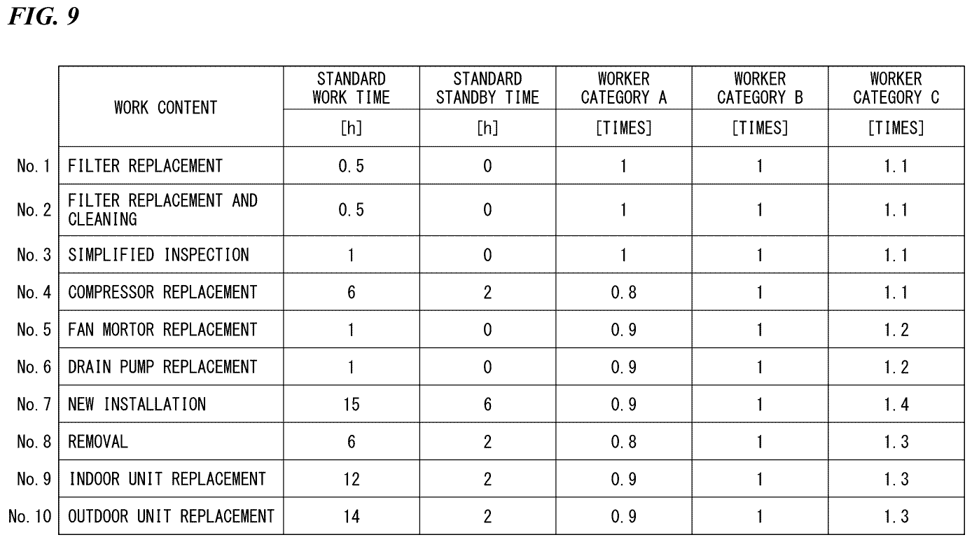

FIG. 9 is a diagram showing a setting example of the work conditions according to the present embodiment. In the shown example, the work content, the standard work time required for the work content (standard work time), and the standby time within the standard work time (standard standby time) are associated with each other.

For example, for the replacement of the outdoor unit No. 10, the standard work time is 14 hours. Therefore, in a case where the maximum work time per day is 8 hours and there is one worker, the work requires two days to complete. Here, there are 16 hours of work time over the two days. Therefore, the maintenance plan creation unit 36 can create the maintenance plan by considering that the total of 4 hours, that is, 2 hours obtained by subtracting the standard work time of 14 hours from the 16 hours (2 days) and 2 hours of standard standby time, can be allocated to other works, such as inspection work.

In addition, the work content is set in association with a category corresponding to the capabilities (for example, proficiency) of the worker. In the shown example, the workers are divided into three categories based on the capabilities (for example, proficiency): a worker category A, a worker category B, and a worker category C. The required work time for each category of worker is expressed as a multiplier with respect to the standard work time.

Here, the worker category A represents a highly proficient worker, the worker category B represents a worker with standard proficiency, and worker category C represents a worker with low proficiency who is not yet accustomed to the work. By multiplying the standard work time by the multiplier for each category, the work time for each category of worker can be calculated. As an example, for the work time for the replacement of the compressor No. 4, the standard work time is 6 hours. However, for the worker of the worker category A, the work time is 4.8 hours (6×0.8=4.8), for the worker of the worker category B, the work time is 6 hours (6×1=6), and for the worker of the worker category C, the work time is 9 hours (6×1.5=9).

For example, the work information reception unit 34 receives, as the work information, an input of worker information (refer to FIG. 9) regarding the standard work time, the standard standby time, the work category indicating the capabilities of the worker for the work (for example, proficiency), and the like. For example, the multipliers for the worker categories can be freely input by the construction companies or the like that perform the work. Then, the work time calculation unit 37 calculates the work time in a case where maintenance is performed at each of the plurality of maintenance timing settings, based on the capabilities of the worker for the work (for example, proficiency). The maintenance plan creation unit 36 creates the maintenance plan for the air conditioner 100 based on the work time calculated by the above-described work time calculation unit 37 when creating the maintenance plan.

As a result, the equipment management system 1 can make more accurate estimates of the work time and the cost by taking into account the capabilities (for example, proficiency) of the worker.

### Third Embodiment

Next, a Third Embodiment Will Be Described.

In the present embodiment, an example of the configuration will be described in which a maintenance plan is created for a timing of cleaning or replacing the filter 29 of the air conditioner 100. As described with reference to FIG. 2 in the first embodiment, the indoor unit 20 of the air conditioner 100 includes the indoor unit fan 21 (an example of a fan), the indoor unit fan motor 22 (an example of a fan motor) that drives the rotation of the indoor unit fan 21, the indoor unit control unit 28 (an example of a control unit) that controls the indoor unit fan motor 22, and the filter 29 (an example of a filter) that is provided in the middle of the airflow generated by the rotation of the indoor unit fan 21.

Here, regular filters are recommended to be cleaned approximately once a year. However, even in a case where the cleaning timing is slightly shifted, it only causes a slight impact on performance and power consumption, and no major issues arise. Additionally, since it only causes a minor impact on performance and power consumption, the cleaning timing of the filter may be set freely by the user. Further, the cleaning timing of the filter may be automatically set depending on the type of the filter.

In addition, the pressure loss (clogging) status of the filter may be detected based on the rotational speed of the fan motor, and the timing for recommending cleaning may be set according to the clogging status. For example, an earlier cleaning timing may be set in a case where cleaning is recommended at 50% clogging, a standard cleaning timing may be set in a case where cleaning is recommended at 70% clogging, and a later cleaning timing may be set in a case where cleaning is recommended at 80% clogging.

For example, the equipment information acquisition unit 31 further acquires fan motor control information from the air conditioner 100 (for example, the indoor unit control unit 28). The fan motor control information refers to, for example, information such as the rotational speed of the indoor unit fan motor 22. The maintenance timing calculation unit 33 calculates the pressure loss of the filter 29 based on the equipment information including the fan motor control information acquired by the equipment information acquisition unit 31 and calculates the timing of cleaning or replacing the filter 29 as the maintenance timing based on the calculated pressure loss of the filter 29.

As a result, the equipment management system 1 can calculate the earlier cleaning timing or replacement timing of the filter 29 prioritized for the maintenance, and the later cleaning timing or replacement timing of the filter 29 prioritized for the cost or the standard cleaning timing or replacement timing of the filter 29, based on the operating time of the air conditioner 100 or the pressure loss of the filter 29 calculated from the fan motor control information, thereby creating the maintenance plan that takes into account the maintenance timing of the filter 29. Accordingly, the equipment management system 1 can create a maintenance plan including the maintenance of the filter 29.

### Fourth Embodiment

Next, a fourth embodiment will be described.

In the present embodiment, an example of the configuration in a case where the content of the maintenance is repair will be described.

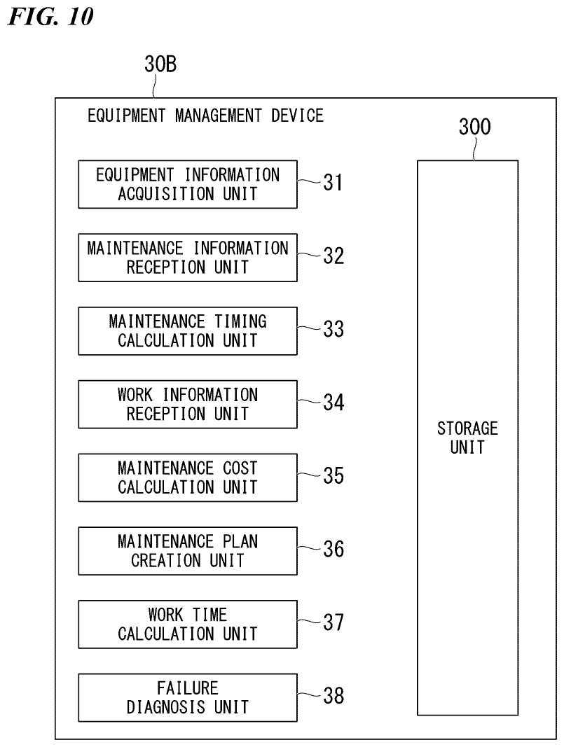

FIG. 10 is a schematic block diagram showing an example of the configuration of an equipment management device 30B according to the present embodiment. In this diagram, the same reference numeral is assigned to the configuration corresponding to each unit of the equipment management devices 30 and 30A shown in FIGS. 3 and 7. The equipment management device 30B is different from the equipment management device 30A shown in FIG. 7 in that a failure diagnosis unit 38 is further provided.

The equipment information acquisition unit 31 further acquires abnormality information related to an abnormality of each of the plurality of air conditioners 100. The abnormality information refers to, for example, information related to failure prediction, such as error information, power consumption, a failure diagnosis result, and a refrigerant leakage diagnosis result.

The failure diagnosis unit 38 predicts a failure timing of the air conditioner 100 based on the operating data and the abnormality information acquired by the equipment information acquisition unit 31. For example, the failure diagnosis unit 38 predicts the failure timing of the component provided in the air conditioner 100 based on the operating data and the abnormality information acquired by the equipment information acquisition unit 31. The maintenance timing calculation unit 33 calculates a repair timing as the maintenance timing based on the failure timing of the air conditioner 100 predicted by the failure diagnosis unit 38.

The failure diagnosis unit 38 diagnoses when and which component is likely to fail during failure timing prediction. However, the failure diagnosis unit 38 does not provide a 100% accurate prediction but instead predicts the probability of failure, such as a 60% probability of failure in ◯ years or a 90% probability of failure in □ years. Therefore, variations in the repair schedule occur depending on the recommended repair timing. For example, in a case where the repair is recommended at a timing at which a 60% probability of failure is predicted, an earlier repair timing is recommended, in a case where the repair is recommended at a timing at which a 70% probability of failure is predicted, a standard repair timing is recommended, and in a case where the repair is recommended at a timing at which a 95% probability of failure is predicted, a later repair timing is recommended.

In terms of cost, it is advantageous to perform repair after the failure. Therefore, in a case where no major issues arise even after the failure, the later repair timing may be set in the distant future.

As a result, the equipment management system 1 can predict the failure timing based on the operating data and the abnormality information acquired from the air conditioner 100 and create a maintenance plan including the repair timing based on the predicted failure timing, thereby preventing the failure in advance.

### Fifth Embodiment

Next, a fifth embodiment will be described.

In the present embodiment, an example of the configuration in a case where the content of the maintenance is the update of the equipment will be described. The update is performed in a case where repair is not possible or in a case where it is cheaper to update to a new product rather than to repair the product. However, similar to the repair, variations in the update schedule occur depending on the recommended update timing.

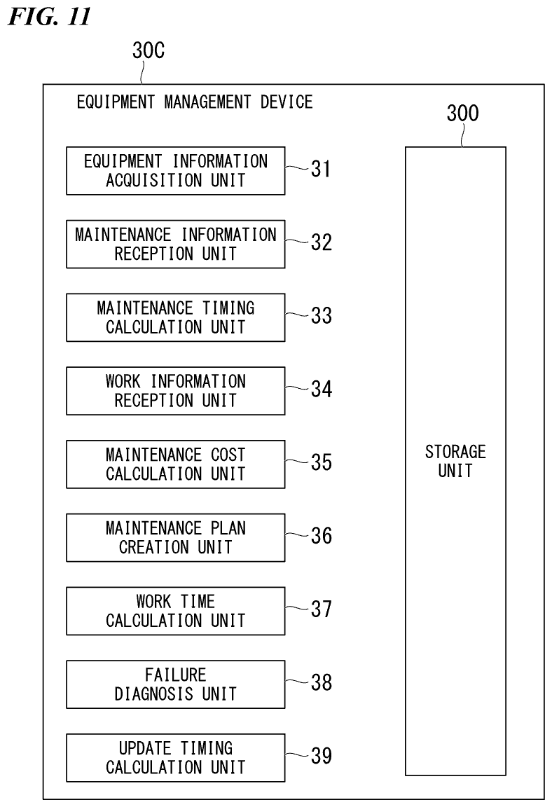

FIG. 11 is a schematic block diagram showing an example of the configuration of an equipment management device 30C according to the present embodiment. In this diagram, the same reference numeral is assigned to the configuration corresponding to each unit of the equipment management devices 30, 30A, and 30B shown in FIGS. 3, 7, and 10. The equipment management device 30C is different from the equipment management device 30B shown in FIG. 10 in that an update timing calculation unit 39 is further provided.

The update timing calculation unit 39 calculates the update timing for substituting the equipment (for example, any one or both of the outdoor unit 10 and the indoor unit 20) provided in the air conditioner 100, based on the operating time included in the operating data acquired by the equipment information acquisition unit 31. The maintenance plan creation unit 36 creates the maintenance plan for the air conditioner 100 including the update timing calculated by the update timing calculation unit 39.

Consequently, the equipment management system 1 can create the maintenance plan including the update timing of the equipment. Additionally, the equipment management system 1 can compare the cost of updating the equipment with the cost of not updating the equipment (for example, repairing the equipment) and check the cost savings.

In addition, as described in the fourth embodiment, the equipment information acquisition unit 31 further acquires the abnormality information related to the abnormality of each of the plurality of air conditioners 100. Further, the failure diagnosis unit 38 predicts the failure timing of the air conditioner 100 based on the operating data and the abnormality information acquired by the equipment information acquisition unit 31. Then, the update timing calculation unit 39 may calculate the update timing of the equipment (for example, any one or both of the outdoor unit 10 and the indoor unit 20) provided in the air conditioner 100 based on the abnormality information and the operating time included in the operating data acquired by the equipment information acquisition unit 31 and the failure timing of the air conditioner 100 predicted by the failure diagnosis unit 38.

As a result, the equipment management system 1 can create the maintenance plan including a more accurate update timing by taking into account the abnormality information, the failure timing prediction, and the like.

Hitherto, the embodiments have been described in detail with reference to the drawings, but specific configurations are not limited to these embodiments, and the embodiments can be modified or omitted as appropriate.

In the above-described embodiments, a case where the equipment installed in the facility is the air conditioner 100 has been described, but the present disclosure is not limited to the air conditioner 100, and the method of creating the maintenance plan described in the above embodiments may be applied to the creation of the maintenance plan for any device.

Additionally, the equipment management device 30 may create a maintenance plan linked to the delivery date for a spare component. For example, in a case where the delivery date for the component is six months, the equipment management device 30 may create a maintenance plan to perform maintenance after six months from the current time.

Further, when creating the maintenance plan, the equipment management device 30 may try all possible combinations of schedules or may use an algorithm that reduces the amount of calculation, such as a genetic algorithm or artificial intelligence (AI).

In addition, in the above-described embodiments, an example of the configuration has been described in which the equipment management device 30 acquires the equipment information, such as the operating data, via the communication network NW (for example, acquires it in real time), but even without a network environment, a method may be employed in which equipment information acquired on-site, such as during inspections, is uploaded to the cloud, allowing the equipment management device 30 to acquire the information.

It should be noted that a program for implementing the functions of the equipment management device 30 may be recorded on a computer-readable recording medium and the program recorded on the recording medium may be loaded into the computer system and executed, thereby performing the processing of the control unit of each equipment. The term “computer system” as used here refers to a computer system that includes an OS and hardware such as a peripheral device.

Additionally, the term “computer-readable recording medium” refers to a portable medium such as a flexible disk, a magneto-optical disk, a ROM, or a CD-ROM, or a storage device such as a hard disk incorporated into the computer system. Further, the term “computer-readable recording medium” also includes a medium that dynamically holds the program for a short period of time, such as communication lines in a case where the program is transmitted via a network such as the Internet or a communication line such as a telephone line, and a medium that holds the program for a certain period of time, such as a volatile memory provided inside the computer system serving as a server or a client in that case. Furthermore, the above-described program may be used to implement a part of the above-mentioned functions and may also be used to implement the above-mentioned functions in combination with programs already recorded in the computer system. Moreover, the above-described program may be stored in a predetermined server, and the program may be distributed (downloaded or the like) via the communication line in response to requests from other devices.

Additionally, a part or all of the functions of the equipment management device 30 may be implemented as an integrated circuit such as a large scale integration (LSI). Each function may be individually processed, or some or all of the functions may be integrated and processed. Further, a method for the integrated circuit is not limited to the LSI and may be implemented using a dedicated circuit or a general-purpose processor. Furthermore, in a case where an integrated circuit technology emerges to replace the LSI due to advances in semiconductor technology, an integrated circuit using that technology may be used.

1. An equipment management system comprising:
equipment information acquisition circuitry to acquire equipment information including a model name and operating data of each of a plurality of pieces of equipment installed in a facility;
maintenance information reception circuitry to receive an input of a maintenance priority indicating a priority of performing maintenance on the equipment;
maintenance timing calculation circuitry to calculate two or more maintenance timings including a first maintenance timing for performing replacement of a component used in the equipment earlier and a second maintenance timing which is later than the first maintenance timing, based on an operating time included in the operating data acquired by the equipment information acquisition circuitry;
work information reception circuitry to receive an input of work information regarding a work time and a cost required for the replacement of the component of each of the pieces of equipment; and
maintenance plan creation circuitry to create and output a maintenance plan for the equipment based on the maintenance timing calculated by the maintenance timing calculation circuitry, the maintenance priority input to the maintenance information reception circuitry, and the work time and the cost input to the work information reception circuitry.

2. The equipment management system according to claim 1, further comprising:
maintenance cost calculation circuitry to select a plurality of maintenance timing settings for each of the pieces of equipment from among the two or more maintenance timings calculated by the maintenance timing calculation circuitry, in accordance with the maintenance priority input to the maintenance information reception circuitry, and calculate a maintenance cost required for each of the plurality of selected maintenance timing settings based on the work time and the cost input to the work information reception circuitry,
wherein the maintenance plan creation circuitry creates the maintenance plan for the equipment based on a maintenance timing setting with a lowest calculated maintenance cost among the plurality of maintenance timing settings selected by the maintenance cost calculation circuitry.

3. The equipment management system according to claim 2, further comprising:
work time calculation circuitry to calculate a work time in a case where maintenance is performed at each of the plurality of maintenance timing settings selected by the maintenance cost calculation circuitry,
wherein the maintenance plan creation circuitry creates the maintenance plan for the equipment based on a maintenance timing setting that satisfies a predesignated work constraint and that has a lowest calculated maintenance cost, among the plurality of selected maintenance timing settings.

4. The equipment management system according to claim 2,
wherein the work information reception circuitry further receives an input of worker information indicating capabilities of a worker for work as the work information,
the equipment management system further comprises work time calculation circuitry to calculate a work time in a case where maintenance is performed at each of the plurality of maintenance timing settings selected by the maintenance cost calculation circuitry, based on the worker information indicating the capabilities of the worker for the work, and
the maintenance plan creation circuitry creates the maintenance plan for the equipment based on the work time calculated by the work time calculation circuitry when creating the maintenance plan.

5. The equipment management system according to claim 1,
wherein the maintenance information reception circuitry further receives an input of inspection information regarding inspection of the equipment, and
the maintenance timing calculation circuitry calculates an inspection timing of the equipment as the maintenance timing based on the equipment information acquired by the equipment information acquisition circuitry and the inspection information input to the maintenance information reception circuitry.

6. The equipment management system according to claim 1,
wherein the equipment comprises
a fan, a fan motor to drive rotation of the fan, control circuitry to control the fan motor, and a filter provided in a middle of an airflow generated by the rotation of the fan,
the equipment information acquisition circuitry acquires fan motor control information from the equipment as the equipment information, and
the maintenance timing calculation circuitry calculates a pressure loss of the filter based on the equipment information including the fan motor control information acquired by the equipment information acquisition circuitry and calculates a timing of cleaning or replacing the filter as the maintenance timing based on the calculated pressure loss of the filter.

7. The equipment management system according to claim 1,
wherein the equipment information acquisition circuitry further acquires abnormality information related to an abnormality of each of the plurality of pieces of equipment,
the equipment management system further comprises failure diagnosis circuitry to predict a failure timing of the equipment based on the operating data and the abnormality information acquired by the equipment information acquisition circuitry, and
the maintenance timing calculation circuitry calculates a repair timing as the maintenance timing based on the failure timing of the equipment predicted by the failure diagnosis circuitry.

8. The equipment management system according to claim 1, further comprising:
update timing calculation circuitry to calculate an update timing for substituting the equipment, based on the operating time included in the operating data acquired by the equipment information acquisition circuitry,
wherein the maintenance plan creation circuitry creates the maintenance plan by taking into account the update timing calculated by the update timing calculation circuitry when creating the maintenance plan.

9. The equipment management system according to claim 8,
wherein the equipment information acquisition circuitry further acquires abnormality information related to an abnormality of each of the plurality of pieces of equipment,
the equipment management system further comprises failure diagnosis circuitry to predict a failure timing of the equipment based on the operating data and the abnormality information acquired by the equipment information acquisition circuitry, and
the update timing calculation circuitry calculates the update timing based on the abnormality information and the operating time included in the operating data acquired by the equipment information acquisition circuitry and the failure timing of the equipment predicted by the failure diagnosis circuitry.

10. An equipment management device comprising:
equipment information acquisition circuitry to acquire equipment information including a model name and operating data of each of a plurality of pieces of equipment installed in a facility;
maintenance information reception circuitry to receive an input of a maintenance priority indicating a priority of performing maintenance on the equipment;
maintenance timing calculation circuitry to calculate two or more maintenance timings including a first maintenance timing for performing replacement of a component used in the equipment earlier and a second maintenance timing which is later than the first maintenance timing, based on an operating time included in the operating data acquired by the equipment information acquisition circuitry;
work information reception circuitry to receive an input of work information regarding a work time and a cost required for the replacement of the component of each of the pieces of equipment; and
maintenance plan creation circuitry to create and output a maintenance plan for the equipment based on the maintenance timing calculated by the maintenance timing calculation circuitry, the maintenance priority input to the maintenance information reception circuitry, and the work time and the cost input to the work information reception circuitry.

11. An equipment management method in an equipment management system, the method comprising:
acquiring, via equipment information acquisition circuitry, equipment information including a model name and operating data of each of a plurality of pieces of equipment installed in a facility;
receiving, via maintenance information reception circuitry, an input of a maintenance priority indicating a priority of performing maintenance on the equipment;
calculating, via maintenance timing calculation circuitry, two or more maintenance timings including a first maintenance timing for performing replacement of a component used in the equipment earlier and a second maintenance timing which is later than the first maintenance timing, based on an operating time included in the operating data acquired by the equipment information acquisition circuitry;
receiving, via work information reception circuitry, an input of work information regarding a work time and a cost required for the replacement of the component of each of the pieces of equipment; and
creating and outputting, via maintenance plan creation circuitry, a maintenance plan for the equipment based on the maintenance timing calculated by the maintenance timing calculation circuitry, the maintenance priority input to the maintenance information reception circuitry, and the work time and the cost input to the work information reception circuitry.

12. A computer readable non-transitory recording medium having a program for causing a computer to execute:
acquiring equipment information including a model name and operating data of each of a plurality of pieces of equipment installed in a facility;
receiving an input of a maintenance priority indicating a priority of performing maintenance on the equipment;
calculating two or more maintenance timings including a first maintenance timing for performing replacement of a component used in the equipment earlier and a second maintenance timing which is later than the first maintenance timing, based on an operating time included in the operating data;
receiving an input of work information regarding a work time and a cost required for the replacement of the component of each of the pieces of equipment; and
creating and outputting a maintenance plan for the equipment based on the calculated maintenance timing, the input maintenance priority, and the input work time and cost.
